(19) United States
(12) Patent Application Publication
(10) Pub. No.: US 2011/0318024 A1
(43) Pub. Date: Dec. 29, 2011

(54) IMAGE FORMING APPARATUS AND IMAGE FORMING METHOD

(75) Inventor: Hiroshi Kawaguchi, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/166,949

(22) Filed: Jun. 23, 2011

Related U.S. Application Data
(60) Provisional application No. 61/359,447, filed on Jun. 29, 2010.

(51) Int. Cl. G03G 15/08

(52) U.S. Cl. 399/27; 399/53

(57) ABSTRACT

An image forming apparatus includes an image forming unit including a developing device, a second toner cartridge replaced for a first toner cartridge storing a first toner having a first characteristic, stores a second toner having a second characteristic, and supplies the second toner to the developing device, a first memory provided in the second toner cartridge, and stores data of the second characteristic, a toner use amount detection mechanism to detect a toner use amount in the developing device after the replacement to the second toner cartridge, a second memory in which a first print condition as an optimum print condition obtained from data of the first characteristic, the second print condition and the toner use amount are written, and an arithmetic mechanism to obtain an execution print condition changed stepwise from the first print condition to the second print condition based on the toner use amount.

### CROSS-REFERENCE TO RELATED APPLICATION

This application is based upon and claims the benefit of priority from the prior U.S. Provisional Patent Application No. 61/359,447 filed on Jun. 29, 2010, the entire contents of which are incorporated herein by reference.

### FIELD

Embodiments described herein relate generally to an image forming apparatus and an image forming method.

### BACKGROUND

In an image forming apparatus, a memory storing characteristic data of developer is provided for each toner cartridge, and control of a print condition of transfer, fixing or the like is performed based on the data so that an optimum image quality is obtained.

At this time, when the toner cartridge is replaced with a new one, data is read from a new memory, and control is performed under a new print condition based on the data.

### BRIEF DESCRIPTION OF THE DRAWINGS

FIG. 1 is a structural view of an image forming apparatus which is a four-tandem color printer of an embodiment;

FIG. 2 is a schematic structural view of an image forming unit of the embodiment;

FIG. 3 is a block diagram of components in which control of a print condition of the embodiment is performed;

FIG. 4 is a correspondence table of address and information content in a memory on a main body side of the embodiment;

FIG. 5 is a correspondence table of address and information content in a memory on a toner cartridge side of the embodiment;

FIG. 6 is a flowchart of the control of the print condition of the embodiment; and

FIG. 7 is a table showing results of evaluation of image density when development potentials of examples are respectively changed.

### DETAILED DESCRIPTION

Reference will now be made in detail to the present embodiment of the invention, an example of which is illustrated in the accompanying drawing.

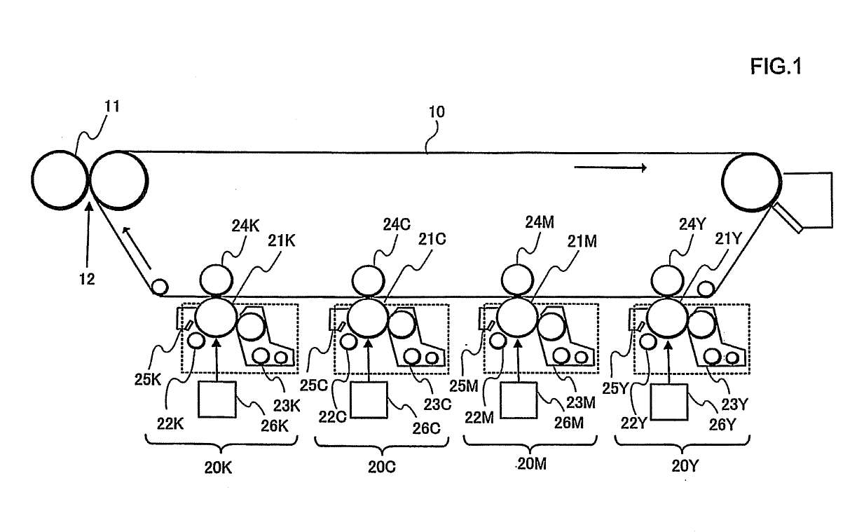

FIG. 1 is a structural view of an image forming apparatus which is a four-tandem color printer and is an example of an image forming apparatus (MFP) of an embodiment. As shown in FIG. 1, a secondary transfer roller 11 to transfer an image on an intermediate transfer belt 10 onto a transfer medium 12, and image forming units 20Y, 20M, 20C and 20K of yellow, magenta, cyan and black are arranged along a conveyance direction (arrow direction) of the intermediate transfer belt 10.

The image forming units 20Y, 20M, 20C and 20K include photoreceptors 21Y, 21M, 21C and 21K as image carriers. Further, chargers 22Y, 22M, 22C and 22K as charging units, developing devices 23Y, 23M, 23C and 23K including developing rollers as developing members and containing developers including respective color toner particles of yellow, magenta, cyan and black and carrier particles, primary transfer rollers 24Y, 24M, 24C and 24K as transfer units, and cleaner units 25Y, 25M, 25C and 25K are provided around the respective photoreceptors. These are respectively arranged along rotation directions of the corresponding photoreceptors 21Y, 21M, 21C and 21K.

The respective primary transfer rollers 24Y, 24M, 24C and 24K are disposed inside the intermediate transfer belt 10, and nip the intermediate transfer belt 10 in cooperation with the corresponding photoreceptors 21Y, 21M, 21C and 21K. Exposure devices 26Y, 26M, 26C and 26K are respectively arranged so that exposure points are formed on outer peripheral surfaces of the photoreceptors 21Y, 21M, 21C and 21K between the chargers 22Y, 22M, 22C and 22K and the developing devices 23Y, 23M, 23C and 23K. The secondary transfer roller 11 is arranged outside the intermediate transfer belt 10 so as to contact therewith.

A print operation is performed as described below by the image forming apparatus constructed as described above. A toner image of yellow formed on the photoreceptor of the image forming unit 20Y is primarily transferred onto the intermediate transfer belt 10. The toner image is formed in the image forming unit 20Y. The same process is performed also in the image forming units 20M, 20C and 20K in synchronization with a timing of the toner image formation in the image forming unit 20Y. The toner images of magenta, cyan and black formed on the photoreceptors of the image forming units 20M, 20C and 20K are also sequentially primarily transferred onto the intermediate transfer belt 10.

The transfer medium 12 is conveyed from a cassette (not shown), and is sent to the intermediate transfer belt 10 by an aligning roller (not shown) in synchronization with the timing of the toner image on the intermediate transfer belt 10.

A bias (+) having a polarity opposite to a toner charge polarity is applied to the secondary transfer roller 11 by a power source (not shown). As a result, the toner image on the intermediate transfer belt 10 is transferred onto the transfer medium 12 by a secondary transfer voltage applied between the intermediate transfer belt 10 and the secondary transfer roller 11. A fixing unit (not shown) to fix the toner transferred on the transfer medium 12 is disposed, and a fixed image is obtained by causing the transfer medium 12 to pass through the fixing unit (not shown).

Incidentally, here, although the description is made on the example in which the image forming units are arranged in the order of yellow, magenta, cyan and black, the color order is not particularly limited.

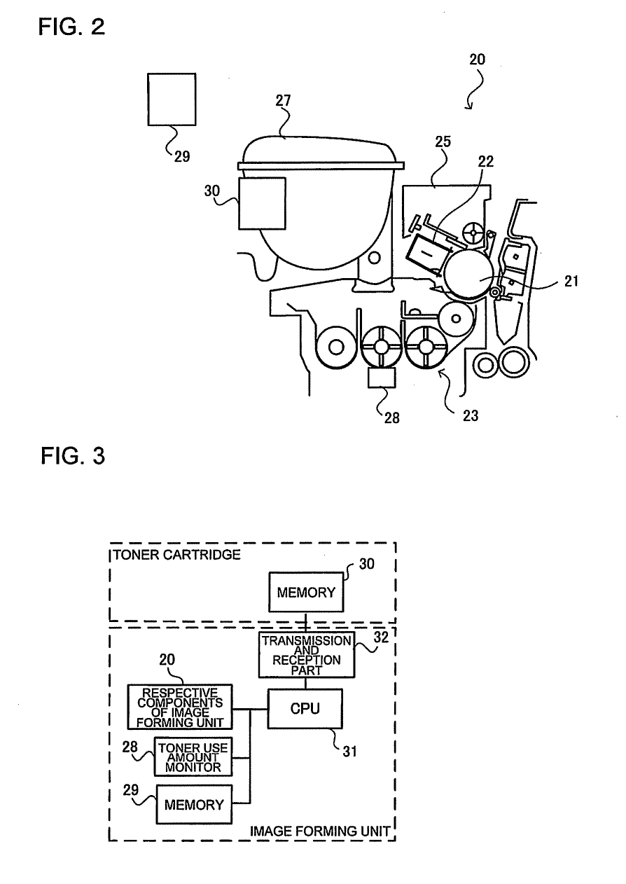

FIG. 2 is a schematic structural view of an image forming unit 20 of the image forming apparatus which is constructed as described above and in which an image is formed. Incidentally, the image forming units 20Y, 20M, 20C and 20K have the same structure.

As shown in FIG. 2, a charger 22, a developing device and a cleaner unit 25 are arranged around a photoreceptor 21. A toner cartridge 27 is mounted to the developing device 23.

The image forming unit 20 includes a toner use amount monitor 28 as a mechanism to detect a toner use amount, such as a pixel number counter, a toner motor rotation time or rotation number counter, a copy amount counter or a development drive time counter, and a memory 29 storing a print condition, such as a development potential varying according to an electric resistance value, and the toner use amount.

The toner cartridge 27 includes a memory 30 storing an electric resistance value in a manufacturing lot of toner contained in the toner cartridge 27.

The memory 30 is not necessarily required to be attached to the toner cartridge 27. When the toner cartridge 27 and the developing device constitute an integral unit, the memory 30 may be attached to the integral unit.

The respective components of the image forming unit are connected to an arithmetic control mechanism (not shown) to control these.

In the image forming unit as stated above, control of the print condition is performed as described below. FIG. 3 is a block diagram of components in which the control of the print condition is performed. As shown in FIG. 3, a CPU 31 as the arithmetic control mechanism is connected to the respective components of the image forming unit 20 and the memory 29 of the image forming unit. The memory 30 is connected to the toner use amount monitor 28.

Further, the CPU 31 is connected to the memory 30 on a toner cartridge 27 side through a wireless or wired transmission and reception part 32, and controls the respective components of the image forming unit 20. Incidentally, the CPU 31 may incorporate the memory 29.

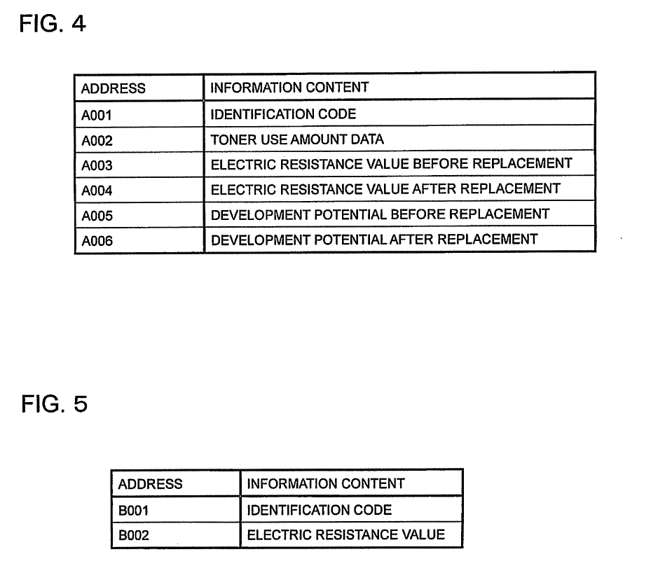

FIG. 4 is a correspondence table of address and information content in the memory 29 on an image forming apparatus side, and FIG. 5 is a correspondence table of address and information content in the memory 30 on the toner cartridge side.

As shown in the table of FIG. 4, the memory 29 includes, for respective addresses, an area (A001) in which an identification code is inputted, and an area (A002) in which toner use amount data detected by the toner use amount monitor 28 is written.

There are provided an area (A003) in which an electric resistance value of toner in a toner cartridge before replacement is stored, and an area (A004) in which an electric resistance value of toner in a toner cartridge after replacement is stored. Further, there are provided areas (A005, A006) in which development potentials are written which are obtained by the CPU 31 from the respective electric resistance values and are surface potentials on the photoreceptor controlled according to the electric resistance values.

As shown in the Table of FIG. 5, the memory 30 on the toner cartridge 27 side includes, for respective addresses, an area (B001) in which an identification code is inputted, and an area (B002) in which an electric resistance value is inputted.

In A004 of the memory 29 and B002 of the memory 30, characteristic data for obtaining the print condition, such as the electric resistance value, is not necessarily required to be written. The print condition such as a development potential may be written. In that case, A005 and A006 of the memory 29 may not be provided.

Incidentally, although the development potential is mentioned as the print condition, the print condition may be a transfer voltage controlled according to a toner charge amount, an average particle diameter and a grain size distribution, or a fixing temperature controlled based on a heat characteristic of toner, such as Tm or Tg, and a heat characteristic of resin contained in the toner.

Besides, since the transfer voltage or the fixing temperature depends on temperature and humidity, a temperature and humidity sensor is provided, the temperature and humidity at printing is acquired by the temperature and humidity sensor, and the optimum transfer voltage or the fixing temperature can be selected from corresponding data of the transfer voltage or the fixing temperature of each toner cartridge and the temperature and humidity. Further, plural print conditions may be controlled.

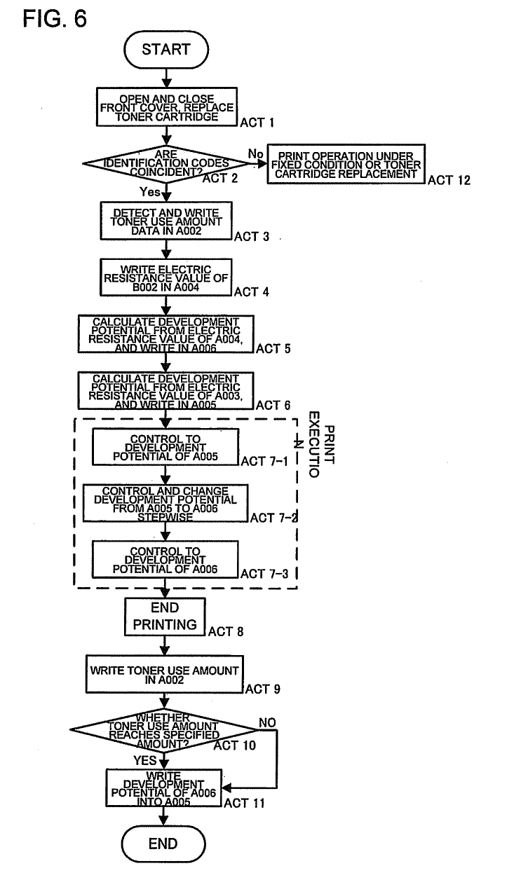

By the structure as stated above, the control of the print condition is performed as described below. FIG. 6 shows a flowchart. As shown in FIG. 6, at the start of printing, a power source is turned ON, a front cover is opened and closed, and a toner cartridge is replaced (Act 1).

It is determined whether the identification code inputted in A001 of the memory 29 is coincident with the identification code inputted in 3001 of the memory 30 (Act 2). When coincident, a print operation is performed. When not coincident, the print operation is performed under a fixed condition or the toner cartridge is replaced by another toner cartridge (Act 12).

The toner use amount monitor 28, such as the copy amount counter, detects the copy amount or the like, and detected toner use amount data such as the copy amount is written in A002 (Act 3).

The electric resistance value inputted in 3002 of the memory 30 is read by the CPU 31 through the transmission and reception part 32, and is written in A004 of the memory 29 (Act 4). A development potential is obtained by the CPU 31 from the electric resistance value written in A004, and is written in A006 (Act 5).

Similarly, a development potential is obtained by the CPU 31 from the electric resistance value in the former toner cartridge previously stored in A003 of the memory 29, and is written in A005 (Act 6).

Based on the development potentials written in A005 and A006 and the toner use amount data written in A002, an actually applied development potential is calculated as described below. The charger is controlled so that the calculated development potential is obtained, and printing is performed.

Immediately after the toner cartridge is replaced, toner in the toner cartridge before the replacement occupies most of the inside of the developing device. Accordingly, immediately after the replacement of the toner cartridge or in a state where the toner use amount is still small, the control is made so that the development potential written in A005 is obtained (Act 7-1).

As the toner use amount increases, the content of the toner in the toner cartridge after the replacement in the developing device increases. Then, based on the toner use amount data of A002, the development potential is controlled to be changed stepwise to the development potential written in A006 (Act 7-2). The development potential is changed at least at one step, and is preferably changed at plural steps or linearly.

In this way, the development potential is changed stepwise according to the remaining amount of the developer before the replacement, and the control is performed so that the development potential written in A006 occurs at the time point when it is estimated that the toner use amount from the replacement of the toner cartridge detected by the toner use amount monitor 28 reaches the toner amount in the developing device (Act 7-3).

Incidentally, the change of the development potential is not necessarily performed from the replacement of the toner to the time point when it is estimated that the toner use amount reaches the toner amount in the developing device. For example, the control may be performed such that the development potential becomes a value between A005 and A006 when the toner use amount is in a specified range. The specified range is, for example, 10-90 wt % of the toner amount in the developing device. In the case of one step, the development potential can be changed to a value between A005 and A006 when the toner use amount is, for example, 30-70 wt % of the toner amount in the developing device.

In this way, the development potential is controlled and the printing is performed. When the printing is ended (Act 8), the toner use amount is written in A002 and is stored (Act 9). It is determined whether the toner use amount after the replacement of the toner cartridge reaches a specified amount such as the toner amount in the developing device (Act 10). When reaches, the development potential written in A006 of the memory 29 is newly written in A005 and is stored (act 11). When not reach, the printing is ended as it is.

When printing is next performed, even when the toner cartridge is not replaced, the development potential is similarly controlled based on the toner use amount stored in A002 and the development potentials stored in A005 and A006.

### Examples

Hereinafter, examples will be described.

### (Preparation of the Developer)

Raw materials such as a coloring agent, a binder resin and a release agent are mixed, melted and kneaded. The kneaded raw materials are pulverized, and then are classified, and an additive is added, so that a toner is formed. Incidentally, the toner may be formed by a chemical production method such as a polymerization method.

The toner formed in this way is mixed with a carrier so that the toner density becomes 8.0 wt %, and a developer A having a low electric resistance value and a developer B having a high electric resistance value are prepared. An optimum development potential for the developer A is −300 V, and an optimum development potential for the developer B is −400 V.

### (Evaluation of the Image Density)

The thus obtained developers A and B of 400 g are respectively stored in toner cartridges A and B. The toner cartridge A is mounted and printing is performed, and then, the toner cartridge A is replaced with the toner cartridge B, and printing is performed as shown in the flowchart of FIG. 6. At that time, the development potential (1) immediately after the replacement (toner supply amount: less than 32 g), (2) in an intermediate state (toner supply amount: 32 to 200 g) in which the developer before the replacement and the developer after the replacement are approximately equal to each other or (3) in a state (toner supply amount: more than 200 g) in which the developer before the replacement is sufficiently consumed is changed to (1) the development potential (−300 V) of the toner cartridge A, (2) a development potential of a value between the development potential (−300 V) of the toner cartridge A and the development potential of the toner cartridge B (−400 V) or (3) the development potential of the toner cartridge B (−400 V), and images are formed on a transfer medium.

An A4 color paper (mondi) is used as the transfer medium, and the density of a formed solidly filled image is measured by a Macbeth densitometer. The evaluation criteria are as follows:

A: the image density is 1.4 or more and less than 1.51,

B: the image density exceeds 1.37 and is less than 1.4, or is 1.51 or more and less than 1.53, and

C: the image density is 1.37 or less or is 1.53 or more.

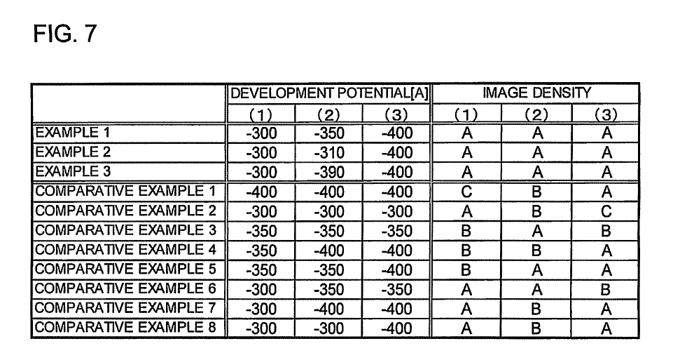

FIG. 7 shows evaluation results of image densities of examples 1-3 and comparative examples 1-8 in which the development potentials of (1) to (3) are respectively changed. As shown in this table, it is understood that in the examples 1-3 in which the development potential is changed stepwise according to the remaining amount of the developer before the replacement, an excellent image density is obtained.

On the other hand, it is understood that in the comparative examples 1-8 in which the development potential is fixed or is changed independently of the remaining amount of the developer before the replacement, an excellent image density can not be obtained in all of (1) to (3).

As stated above, in the image forming apparatus in which the memory storing the developer characteristic data is provided for each toner cartridge, and the print condition of transfer, fixing or the like is controlled based on the data so that the optimum image quality is obtained, the excellent print state can be obtained by changing the development potential stepwise according to the remaining amount of the developer before the replacement in the developing device.

While certain embodiments have been described, these embodiments have been presented by way of example only, and are not intended to limit the scope of the inventions. Indeed, the novel embodiments described herein may be embodied in a variety of other forms; furthermore, various omission, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit including a developing device;
a second toner cartridge which is replaced for a first toner cartridge storing a first toner having a first characteristic, stores a second toner having a second characteristic, and supplies the second toner to the developing device;
a first memory which is provided in the second toner cartridge, and the first memory configured to store data of the second characteristic or a second print condition as an optimum print condition obtained from the data of the second characteristic;
a toner use amount detection mechanism configured to detect a toner use amount in the developing device after the replacement to the second toner cartridge;
a second memory in which a first print condition as an optimum print condition obtained from data of the first characteristic, the second print condition and the toner use amount are written; and
an arithmetic control mechanism configured to obtain an execution print condition, which is changed stepwise from the first print condition to the second print condition, based on the toner use amount.

2. The apparatus of claim 1, wherein the arithmetic control mechanism controls the image forming unit to cause printing to be performed under the execution print condition.

3. The apparatus of claim 1, wherein the execution print condition is a value between the first print condition and the second print condition when the toner use amount is in a specified range.

4. The apparatus of claim 1, wherein the stepwise change is one of a one-step change, a multi-step change and a linear change.

5. The apparatus of claim 1, wherein the first print condition, the second print condition and the execution print condition are at least one of a development potential, a transfer voltage and a fixing temperature.

6. The apparatus of claim 1, wherein the first characteristic and the second characteristic are at least one of an electric resistance value of the toner, a charge amount of the toner, an average particle diameter of the toner, a grain size distribution of the toner, a heat characteristic of the toner, and a heat characteristic of a resin contained in the toner.

7. The apparatus of claim 1, wherein the arithmetic control mechanism obtains the first print condition and the second print condition from the first characteristic and the second characteristic.

8. The apparatus of claim 1, wherein the first characteristic and the second characteristic are written in the second memory.

9. The apparatus of claim 1, wherein the toner use amount detection mechanism is one of a pixel number counter, a toner motor rotation time or rotation number counter, a copy amount counter and a development drive time counter.

10. An image forming method comprising:
replacing a first toner cartridge, which is mounted on a developing device provided in an image forming unit and stores a first toner having a first characteristic and to be printed under a first print condition, with a second toner cartridge storing a second toner having a second characteristic and to be printed under a second print condition;
detecting a toner use amount in the developing device after the replacement to the second toner cartridge;
storing the first print condition and the second print condition;
obtaining an execution print condition, which is changed stepwise from the stored first print condition to the second print condition, based on the toner use amount; and
performing printing.

11. The method of claim 10, wherein the execution print condition is a value between the first print condition and the second print condition when the toner use amount is in a specified range.

12. The method of claim 10, wherein the specified range is 10-90 wt % of a toner amount in the developing device.

13. The method of claim 10, wherein the stepwise change is one of a one-step change, a multi-step change and a linear change.

14. The method of claim 10, wherein the first print condition, the second print condition and the execution print condition are at least one of a development potential, a transfer voltage and a fixing temperature.

15. The method of claim 14, wherein temperature and humidity are acquired, and at least one of an optimum transfer voltage and an optimum fixing temperature of the first toner and the second toner is selected based on the acquired temperature and humidity.

16. The method of claim 10, wherein the first characteristic and the second characteristic are at least one of an electric resistance value of the toner, a charge amount of the toner, an average particle diameter of the toner, a grain size distribution of the toner, a heat characteristic of the toner, and a heat characteristic of a resin contained in the toner.

17. The method of claim 10, wherein the first print condition and the second print condition are obtained from the first characteristic and the second characteristic.

18. The method of claim 10, wherein the toner use amount is detected based on one of a pixel number, a toner motor rotation time or rotation number, a copy amount and a development drive time.

19. The method of claim 10, wherein the toner use amount when the printing is ended is stored.

20. The method of claim 10, wherein when the printing is ended, it is determined whether the toner use amount reaches a specified amount.
